(19) United States
(12) Patent Application Publication
(10) Pub. No.: US 2026/0309289 A1
(43) Pub. Date: Oct. 8, 2026

(54) TRACK-BASED LIGHTING SYSTEM

(71) Applicant: SIGNIFY HOLDING B.V., EINDHOVEN (NL)

(72) Inventors: BARTEL MARINUS VAN DE SLUIS, EINDHOVEN (NL); MARCELLINUS PETRUS CAROLUS MICHAEL KRIJN, EINDHOVEN (NL); OLIVER FRANCIS BURKE, EINDHOVEN (NL); LEENDERT TEUNIS ROZENDAAL, VALKENSWAARD (NL)

(21) Appl. No.: 19/108,226

(22) PCT Filed: Aug. 28, 2023
(86) PCT No.: PCT/EP2023/073474

§ 371 Date: Mar. 3, 2025

(30) Foreign Application Priority Data
Sep. 5, 2022 (EP) 22193831.9

(51) Int. Cl. F21S 8/04; F21S 2/00; F21V 21/02; F21V 21/35; F21Y 103/20; F21Y 105/16; F21Y 105/18

(52) U.S. Cl. CPC F21S 8/043; E04B 9/006; F21S 2/005; F21S 8/046; F21V 21/025; F21V 21/048; F21V 21/35; F21Y 2103/20; F21Y 2105/16; F21Y 2105/18

(57) ABSTRACT

A lighting system comprising power tracks and lighting panels. The lighting panels are mechanically supported by a set of at least two power tracks, and draw power from one or more power lines carried by the at least two power tracks.

### FIELD OF THE INVENTION

The present invention relates to the field of lighting systems, and in particular, to track-based lighting systems.

### BACKGROUND OF THE INVENTION

Conventional dropped or drop ceilings reduce design freedom for an environment, and make such environments feel smaller. A dropped ceiling is a secondary ceiling that hangs below a main ceiling. Typical dropped ceiling are configured to form a closed system in which a view of the main ceiling is blocked. Moreover, closed system ceilings have become seen as outdated, and over the last decades, people have started to appreciate the industrial appearance of a building infrastructure.

This has resulted in a recent trend towards semi-open ceiling structures, in which a dropped ceiling is replaced by a grid of elongate elements or tracks. This allows an individual to see at least a portion of the main ceiling. One area of particular interest is to replace a dropped ceiling with a grid of power tracks, which each carry one or more power lines. The grid of power tracks can be used to power electrical devices such as lights hanging from the main ceiling. This provides flexibility in the location and/or height of the electrical lights.

There is an ongoing desire to improve the flexibility of placing electrical devices in a semi-open ceiling structure.

WO2014135556A2 discloses a lighting system comprising a track having a first and a second rail, mutually extending equidistantly.

### SUMMARY OF THE INVENTION

The invention is defined by the claims.

According to examples in accordance with an aspect of the invention, there is provided a lighting system comprising a plurality of power tracks lying in a first plane, each power track being formed from a rigid material and carrying one or more power lines for carrying power; and
one or more lighting panels for emitting light, each lighting panel being:
   mechanically coupled to a respective set of power tracks, comprising at least two of the plurality of power tracks, to thereby be structurally supported by the respective set of power tracks; and
   configured to draw power from the one or more of the power lines,
wherein each power track comprises a housing defining a cavity having an opening facing away from an upper surface of the power track,
wherein the one or more power lines are carried within the cavity of the housing and being configured for the placement and powering of an electrical device, each power track comprises electrical contacts on the upper surface for facing a ceiling and mechanically and electrically coupling to the lighting panel; and each lighting panel is configured to rest upon the upper surface of each power track of the respective set of power tracks to thereby mechanically couple the lighting panel to the respective set of power tracks.

The lighting system could have the feature that it comprises a first set of one/two or more coupling elements configured for providing mechanical coupling to a first power track, and a second set of one/two or more coupling elements configured for providing mechanical coupling to a second power track.

In another wording, the invention could be described as a lighting system comprising: a plurality of power tracks lying in a first plane, each power track being formed from a rigid material and carrying one or more power lines carrying power; and one or more lighting panels for emitting light, each lighting panel being: mechanically coupled to a respective set of power tracks, comprising at least two of the plurality of power tracks, to thereby be structurally supported by the respective set of power tracks; and configured to draw power from the one or more of the power lines carried by the respective set of power tracks.

In yet still another wording, the invention could be described as a lighting system comprising a plurality of power tracks lying in a first plane, each power track being formed from a rigid material and comprises suspension means for suspension from a ceiling (and as for example provided on/at an upper surface or further surface portion of the power track), wherein each power track comprises a first cavity defined by an interior surface of a wall facing the cavity and supporting one or more power lines, the first cavity having an opening facing away from the suspension means (i.e. in a horizontal or a downward direction when suspended from a ceiling) and being configured for the placement and powering of an electrical device (i.e. lighting devices like luminaires, lights, spotlights, sensors, etc . . . ), wherein the wall of each power track comprises a further surface facing away from the first cavity and comprising electrical contacts being configured to electrically couple a lighting panel, the further surface comprising a further surface portion facing towards the suspension means (i.e. facing upwardly when suspended from a ceiling), and wherein a first and second power track of the plurality of power tracks are configured to together mechanically carry the lighting panel (arranged on either side of the lighting panel) by their respective further surface portion.

The proposed approach makes use of power tracks to provide both structural support to and electrical powering of lighting panels. In particular, each lighting panel is structurally supported by a set of power tracks, and is configured to draw power from power lines carried by the set of power tracks.

The disclosed technique provides a highly flexible and secure mechanism for installation of lighting elements (in the form of lighting panels) within a plurality of power tracks. In particular, a need to provide separate light mounts or supports is avoided and lighting panels are always provided close to a source of electricity/power.

Examples of suitable rigid materials for forming a power track capable of supporting a lighting panel are well known in the art, and include metals (such as steel), plastics or even wood.

Each power track may comprise a structure defining a cavity having an opening, wherein the one or more power lines are carried within the cavity of the structure. In particular, an interior wall of the structure defines a cavity within the structure. The one or more power lines may be supported on the interior wall of said structure.

In some examples, each power track further comprises one or more return lines providing a return path for power; and each lighting panel is configured to electrically connect to one or more of the return lines carried by the respective set of power tracks.

Where relevant, the return line may be carried within the cavity of a structure defining the power track.

Optionally, each lighting panel is configured to electrically connect to at least one power line and at least one return line carried by a single one of the power tracks in the respective set of power tracks.

In some examples, each lighting panel is configured to: electrically connect to a power line carried by one of the power tracks in the respective set of power tracks; and electrically connect to a return line carried by another one of the power tracks in the respective set of power tracks.

Each lighting panel may comprises one or more coupling elements configured to mechanically couple the lighting panel to the respective set of tracks and/or electrically couple the lighting panel to one or more power lines carried by the respective set of power tracks. Thus, the lighting panel need only connect to the power line(s) carried by a single one of the power tracks, or to power lines carried by multiple power tracks.

Each at least one coupling element may be detachably connected to the remainder of the lighting panel. This provides a mechanism for increased ease of installing the lighting panel to the set of power track(s). This approach also allows for existing lighting panels to be adapted for use with the proposed lighting system, e.g., as the detachable coupling element(s) can be used to adapt an existing lighting panel for connection to a set of power tracks.

In some examples, each power track comprises an upper surface for facing a ceiling and mechanically coupling to a lighting panel.

Optionally, each lighting panel is configured to rest upon the upper surface of each power tracks in the respective set of power tracks to thereby mechanically couple the lighting panel to the respective set of power tracks.

In this way, the set of power tracks effectively supports an underside or lower surface of the lighting panel (i.e., provides a support from underneath). This provides a lighting system that is easy to install or assemble, e.g., as it simply requires placement of the lighting panel on the set of power tracks. This allows for easy manipulation or repositioning of the lighting panel(s) about the plurality of power tracks.

Optionally, each power track carries at least one electrical contact positioned on the upper surface of the power track, each electrical contact being electrically connected to one of the one or more power lines carried by the power track; and each lighting panel is configured to electrically connect to one or more of the electrical contacts carried by the respective set of power tracks.

In some examples, each power track comprises a projection that extends upwardly from the upper surface; and each lighting panel comprises: at least one electrical connector, each configured to electrically connect to at least one electrical contact carried by a single one of the respective set of power tracks; and for each electrical connector: a moveable support configured to structurally support the electrical connector; and a biasing element configured to push the moveable support against the projection of the single one of the respective set of power tracks.

Each power track may a first cavity, carrying a first power line, and having an opening that faces a first direction; and a second cavity, carrying a second power line, having an opening that faces a second, opposite direction. Each lighting panel may be configured to electrically connect to the first power line carried by one of the power tracks in the respective set of power tracks.

The plurality of power tracks may comprise at least 10 power tracks.

Each lighting panel is preferably substantially planar or flat.

In some examples, at least one of the plurality of power tracks comprises: a lower surface, configured to face away from a ceiling; and a lower surface electrical contact at the lower surface, and configured to provide power to one or more luminaires or electrical devices coupled to the power track.

The one or more power tracks may be arranged in a first grid pattern or geometric pattern. A geometric pattern is a non-rectangular arrangement of the power tracks, e.g., so that an angle between at least two of the power tracks is not 90° 5°, e.g., is in a region of between 20° and 70°. This provides a more interesting geometric shape for the plurality of power tracks and the overall lighting system.

The lighting system may further comprise one or more lighting tracks, each lighting track being formed of a rigid material and carrying one or more elongate light emitting elements.

In some examples, the one or more power tracks and the one or more lighting tracks are arranged in a second grid or geometric pattern.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a lighting system;

FIG. 2 provides a sectional view of a lighting system according to an embodiment;

FIG. 3 provides a sectional view of a lighting system according to another embodiment;

FIG. 4 provides a sectional view of a lighting system according to another embodiment;

FIG. 5 provides a sectional view of a lighting system according to another embodiment;

FIG. 6 provides a sectional view of a lighting system according to another embodiment;

FIG. 7 provides a sectional view of a lighting system according to another embodiment;

FIG. 8 provides a sectional view of a portion of a lighting system according to another embodiment;

FIG. 9 illustrates a first arrangement for a plurality of power tracks; and

FIG. 10 illustrates a second arrangement for a plurality of power tracks.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a lighting system comprising power tracks and lighting panels. The lighting panels are mechanically supported by a set of at least two power tracks, and draw power from one or more power lines carried by the at least two power tracks.

Embodiments are based on the realization that it is possible to use an arrangement of power tracks to structurally support and power lighting panels for illuminating an environment. This reduces the number of structural components needed to provide lighting panels at a lower height (relative to a ceiling) compared to existing approaches.

Proposed concepts may be employed in a wide variety of environments, but find particular use in office or clinical environments where it would be beneficial to increase a feeling of space to individuals within said environments.

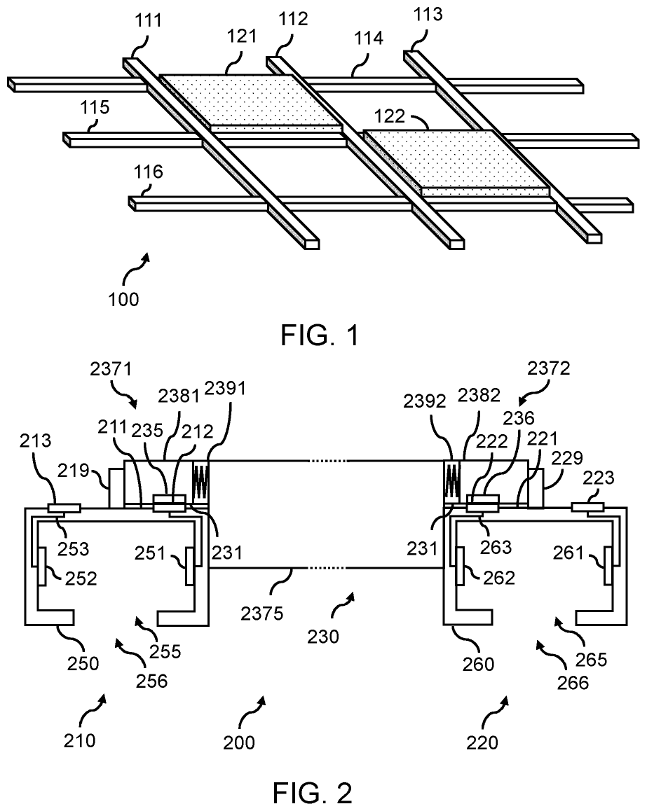

FIG. 1 illustrates a portion of a lighting system 100. The lighting system comprises a plurality of power tracks 111, 112, 113, 114, 115, 116 and one or more lighting panels 121, 122.

The power tracks are formed of a rigid material and are configured to carry one or more power lines (not visible) which themselves carry power, i.e., electricity for powering an electrical device such as a lighting panel. By way of example only, a power line may be formed from a linear, rigid piece of electrically conductive material (e.g., metal) configured to carry power for powering one or more lighting elements.

It is reasonably well established that a power track can comprise a structure or housing having a cavity (not shown). The structure or housing is typically elongate or linear. The structure also defines an opening that permits access to the cavity, i.e., an opening to the cavity. The cavity carries the one or more power lines therein, such that an external device is able to access the one or more power lines via the opening. In particular, the one or more power lines may be carried within a linear cavity (not visible) of the power track.

Suitable examples of rigid materials for forming a power track are well known in the art, including steel, aluminum, plastic or even wood. Any power line carried by any of the power tracks may be insulated from the remainder of the power track (e.g., using an insulating material such as plastic, rubber or the like).

In the proposed configuration, each of the power tracks lie in a same, first plane.

Each power line is linearly formed, i.e., is linear. The power lines may, as illustrated, be arranged in a rectilinear grid or rectilinear grid-like pattern. Other suitable examples for the arrangement of the power lines will be provided later in this disclosure.

Each lighting panel is configured for emitting light out of a light output surface (not visible). Typically, a lighting panel of a lighting system is configured to emit this light in a general downwards direction, e.g., towards a floor or ground, but this is not essential.

A lighting panel is a generally planar element that emits light, and may comprise one or more light emitting elements (such as LEDs). Other elements of the lighting panel may include a diffuser and/or lens arrangement, driving or power conversion circuitry and/or control circuitry. Other suitable elements will be apparent to the skilled person.

Each lighting panel 121, 122 is mechanically coupled to a set of power tracks 111, 112, 113. Each set of power tracks comprises at least two of the plurality of power tracks. Different lighting panels may be connected to the same set of power tracks or different sets of power tracks. Each lighting panel is therefore associated with a particular set of power tracks.

In this way, each lighting panel is mechanically supported by an associated set of power tracks. In particular, each lighting panel is positioned between a set of power tracks and is mechanically supported by said power tracks.

In the illustrated example, a first lighting panel 121 is mechanically coupled to a first 111 and second 112 power track. Optionally, the first lighting panel is mechanically coupled to further power tracks 114, 115, but this is not essential. Similarly, a second lighting panel 122 is mechanically coupled to the second 112 and a third 113 power track. Optionally, the second lighting panel is mechanically coupled to other power tracks 115, 116, but this is not essential.

The set of power tracks to which any lighting panel is mechanically coupled provides structural support to said lighting panel(s). In this way, each lighting panel is structurally supported by a set of power tracks.

The lighting panel(s) 121, 122 are configured to lie in a plane parallel to the first plane, e.g., in the first plane itself or directly above or below the first plane.

Each lighting panel is also configured to draw power from one or more power lines carried by the set of power tracks to which it is mechanically coupled—i.e., from one or more of the power lines carried by any of its associated set of power tracks.

In some examples, each power track 111, 112, 113, 114, 115, 116 further comprises one or more return lines providing a return path for power; and each lighting panel is configured to electrically connect to one or more of the return lines carried by the respective set of power tracks.

By way of example, the power line may provide a positive voltage or power for powering the lighting panel, with the return line providing a ground or earthed voltage for the lighting panel (i.e., a return path for electricity).

As another example, the power and return lines can effectively provide a differential power supply, e.g., the power line providing a positive voltage and the return line providing a negative voltage. Of course, if carrying an AC signal, then a power line can become a return line and a return line can become a power line as the AC signal alternates. In one example, each lighting panel 121, 122 is configured to electrically connect to at least one power line and at least one return line carried by a single one of the power tracks in the respective set of power tracks. Thus, a single power track may provide both the power line and the return line for a lighting panel.

In another example, each lighting panel is configured to electrically connect to a power line carried by one of the power tracks in the respective set of power tracks; and electrically connect to a return line carried by another one of the power tracks in the respective set of power tracks. Thus, two different power tracks may carry the power line and the return line used by a lighting panel.

Examples of both of these approaches will be provided later in this disclosure.

In the illustrated example, the one or more lighting panels 121, 122 comprises two lighting panels. However, the skilled person will appreciate that the lighting system may comprise any number of lighting panels, e.g., a single lighting panel or more than two lighting panels (e.g., 3, 4, 8, 16, 32 or more lighting panels). The maximum number of lighting panels will only be restricted by the available space defined by the plurality of power tracks for positioning lighting panels.

In the illustrated example, the plurality of power tracks 111, 112, 113, 114, 115, 116 comprises at least three and no more than six power tracks. However, the greater the number of power tracks, the greater the flexibility and choice of installation position. Thus, in preferred examples, the plurality of power tracks comprises at least 10 power tracks, e.g., at least 20 power tracks. Of course, any number of power tracks can be used, e.g., only 2 power tracks, more than 2 power tracks and so on.

This lighting system 100 effectively provides an open ceiling grid structure, comprising at least two (linear) power tracks 111, 112, 113, 114, 115, 116 positioned in one plane. The power tracks provide power and structural to support to one or more lighting panels 121, 122 that are positioned in between the tracks.

As illustrated in FIG. 1, the plurality of power tracks 111, 112, 113, 114, 115, 116 define a plurality of segments or cells that are bounded by the power tracks. The lighting panel(s) can be positioned within any one of the segments or cells.

It is not essential that all linear elements of the lighting system be power tracks. For instance, instead of being power tracks, elements 114, 115 and 116 may instead comprise linear lighting tracks. A lighting track is formed of a rigid material and carries one or more elongate light emitting elements.

Use of power tracks enables placement of lighting panels at certain positions, whilst also facilitates flexible placement of other electronic or power-drawing components (such as pendant lights, spotlight, sensors and so on).

It has been recognized that modifications may need to be made to existing lighting systems having power tracks in order to facilitate the use of power tracks as both a support and power provider to the lighting panel(s).

The present disclosure proposes a number of possible modifications or configurations of power tracks and/or lighting panels that can achieve this function.

FIG. 2 illustrates one example of a suitable lighting system 200, which again comprises a plurality of power tracks 210, 220 (of which two are illustrated) and one or more lighting panels 230 (one of which is illustrated). In particular, FIG. 2 provides a sectional view of a portion of a lighting system.

As previously explained, a power track 210, 220 will typically comprise a structure or housing 250, 260 having a cavity that carries one or more power lines 251, 261 and, optionally, a return line 252, 262. The structure also defines an opening that permits access to the cavity, i.e., an opening to the cavity.

In the illustrated example, each power track 210, 220 comprises a C-shaped housing 250, 260 that encloses (within a cavity 255, 265) a power line 251, 261 and a return line 252, 262. This matches conventional power track configurations. The opening 256, 266 to the cavity 255, 265 faces in a downward direction. The C-shaped housing 250, 260 may, for instance, be replaced by a U-shaped housing in some embodiments.

The lighting panel 230 is mechanically coupled to the power tracks 210, 220, to be thereby structurally supported by the power tracks 210, 220.

In particular examples, the lighting panel 230 may comprise at least one coupling element 2371, 2372 (here: two coupling elements) for mechanically coupling the lighting panel 230 to the power tracks 210, 220. In this way, the coupling element(s) are configured to mechanically couple the remainder of the lighting panel to the respective set of tracks.

The lighting panel 230 may be conceptually divided into a main body 2375 and the two or more coupling elements 2371, 2372. The main body 2375 carries/comprises the light emitting element(s) and/or other components such as the diffuser and/or lens arrangement, driving or power conversion circuitry and/or control circuitry. The main body 2375 is substantially planar in shape.

In particular, the lighting panel 230 may comprise a first 2371 and second 2372 coupling element positioned on either side of the main body 2375 of the lighting panel.

In the illustrated example, each power track 210, 220 comprises an upper surface 211, 221 for facing a ceiling and mechanically coupling to a lighting panel. Correspondingly, the lighting panel 230 is configured to mechanically couple (e.g., rest) on the upper surface(s) 211, 221 of the power tracks.

Thus, an underside or lower surface 231 of the lighting panel is able to rest on (and therefore be mechanically coupled to) upper surfaces 211, 222 of the power tracks 210, 220. This approach means that a lighting panel can be simply placed on top of the power tracks 210, 220 and be immediately supported.

In particular the coupling element(s) 2371, 2372 of the lighting panel 230 provide the surfaces of the lighting panel that rest or mechanically couple to the upper surfaces of the power tracks 210, 220 to thereby structurally support the lighting panel on the power tracks.

In the illustrated example, the upper surface(s) 211, 221 of each power track (on which the lighting panel rests) is/are positioned at the uppermost part of the housing 250, 260 of that power track 210, 220.

To provide the electrical power for the lighting panel 230, each power track 210, 220 may comprise at least one electrical contact 212, 213, 222, 223 on its upper surface 211, 221. This differs from conventional power tracks, in which electrical connection can typically only be made within the cavity 255, 265 defined by the housing 250, 260 of the power track. Each electrical contact is coupled to a power line 251, 261 or return line 252, 262 carried by the power track. For instance, each electrical contact may be coupled to a return/power line 251, 252, 261, 262, carried in the cavity 255, 265 of the power track 210, 220, by a via or interconnect 253, 263.

Correspondingly, the lighting panel 230 is configured to electrically connect to the one or more electrical contacts 212, 213, 222, 223 on the upper surface 211, 221 of the power tracks 210, 220. In particular, the lighting panel may comprise (or be coupled to) at least one electrical connector 235, 236, each configured to couple or connect to the electrical contact(s) of the tracks on which the lighting panel rests.

Each electrical connector 235, 236 may be formed in one or more of the coupling elements 2371, 2372 of the lighting panel 230. In this way, the coupling element(s) may be configured to electrically couple the lighting panel to the one or more power lines carried by the respective set of tracks.

Preferably, and as illustrated, the lighting panel 230 is configured to electrically connect to the power line 251 carried by one 210 of its associated set of power tracks and electrically connect to the return line 262 carried by another 220 of its associated set of power tracks. The electrical connection is performed via the electrical contacts 235, 236 of the tracks and the electrical connectors 235, 236.

In this way, the lighting panel 230 has connectors 235, 236 positioned on two sides thereof. Each of a pair of power tracks thereby only requires the provision of a single polarity (of power) at each of these two sides of the lighting panel in order to provide the lighting panel 230 with the required electrical connection(s) to power the lighting panel.

An alternative approach, in which the lighting panel connects to a power line and return line carried by a same power track, is provided later in this disclosure.

In the illustrated example, each power track 210, 220 comprises a projection 219, 229. The projection 219, 229 extends upwardly from the upper surface 211, 221 of its respective power track 210, 220. The projection 219, 229 may be formed integrally with the housing 250, 260 of the corresponding power track.

The lighting panel 230, particularly each coupling element 235, 236 of the lighting panel 230, may comprise one or more supports 2381, 2382 each configured to structurally support one or more of the electrical connector(s) 235, 236. For instance, a first support 2381 may support a first electrical connector 235 and a second support 2382 may support a second electrical connector 236. Each support 2381, 2382 is configured to abut against a projection 219, 229 of a power track when the lighting panel 230 is positioned to be supported by the set of power tracks 210, 220. For instance, the first support 2381 may abut against the projection 219 of a first power track 210 and the second support 2382 may abut against the projection 229 of a second power track 220.

For each support 2381, 2382, when abutting the corresponding projection 219, 229, each electrical connector 235, 236 carried by the support 2381, 2382 is spatially aligned with an electrical contact 212, 222 of the power track comprising the corresponding projection, so as to electrically connect the electrical connector and the electrical contact.

Thus, the position of the electrical connector 235, 236 (of the lighting panel 230) with respect to the support 2381, 2382 and the position of the electrical contact 212, 222 (of the power track 210) with respect to the projection 219, 229 are configured to geometrically/spatially correspond to one another.

To account for slight differences in the distance between power tracks 210, 220 (e.g., due to installation error, installation restrictions or the like), the lighting panel 230, and particularly the coupling element(s) 2371, 2372, may comprise (for each support) a biasing element 2391, 2392 configured to push or bias the support 2381, 2382 against the projection 219, 229 of the single one of the respective set of power tracks. Suitable examples of biasing elements include springs or hydraulic systems. Thus, each support 238 may be a movable support.

This approach facilitates an automatic spatial alignment between each pair of electrical contact (of the power track) and corresponding electrical connector (of the lighting panel).

Use of a biasing element in this way can also increase an ease of installation of a lighting panel into a plurality of power tracks. For instance, the biasing element may be configured such that, during installation, an individual is able to depress the support(s) 238 to insert/install the lighting panel between two power tracks.

The biasing element(s) 2391, 2392 can, of course, be emitted in some embodiments.

An alternative way to solve or overcome the problem of spatially aligning the electrical contact(s) (on the power track(s)) and the electrical connector(s) is to increase a size of the electrical contact 212, 213, 222, 223 and/or electrical connector 235, 236. This can provide an increased tolerance to for the position of the lighting panel 230 with respect to the power tracks.

The electrical contacts 212, 213, 221, 223 on the power tracks 210, 220 and the electrical connector(s) 235, 236 on the panel 230 may both be elongated or linear. However, in alternative examples, only the electrical contacts 212, 213, 221, 223 on the power track are elongated (i.e., extends in a direction of its power track), whilst the connector(s) on the lighting panel 230 can be is shaped in the manner of a “point” connector, e.g., a conventional pad for making electrical contact.

It has been previously explained how the lighting panel may comprise at least one coupling element 2371, 2372, e.g., at least two coupling elements. The coupling elements provide the mechanical and/or electrical coupling between the lighting panel and the power tracks to which the lighting panel is coupled.

In the illustrated examples, the at least one coupling elements comprises two coupling elements. However, the skilled person will appreciate that each lighting panel may comprise any number of coupling elements, e.g., a single coupling element or more than two coupling elements (e.g., 3, 4, 8, 16, 32 or more coupling elements). In particular, there may be a first set of one/two or more coupling elements (for providing mechanical coupling to a first power track) and a second set of one/two or more coupling elements (for providing mechanical coupling to a second power track).

In preferred examples, at least one (e.g., each) coupling element 2371, 2372 is detachably connected or coupled to the main body 2375 of the lighting panel 230. The detachable coupling can be achieved, for instance, using a clipping, screw-based or similar coupling system. Where appropriate, electrical connection between the main body 2375 of the lighting panel and any electrical connectors carried by the coupling element(s) 2371, 2372 can be achieved using established means.

In alternative examples, each coupling element 2371, 2372 may be fixedly coupled to the main body 2375 of the lighting panel 230.

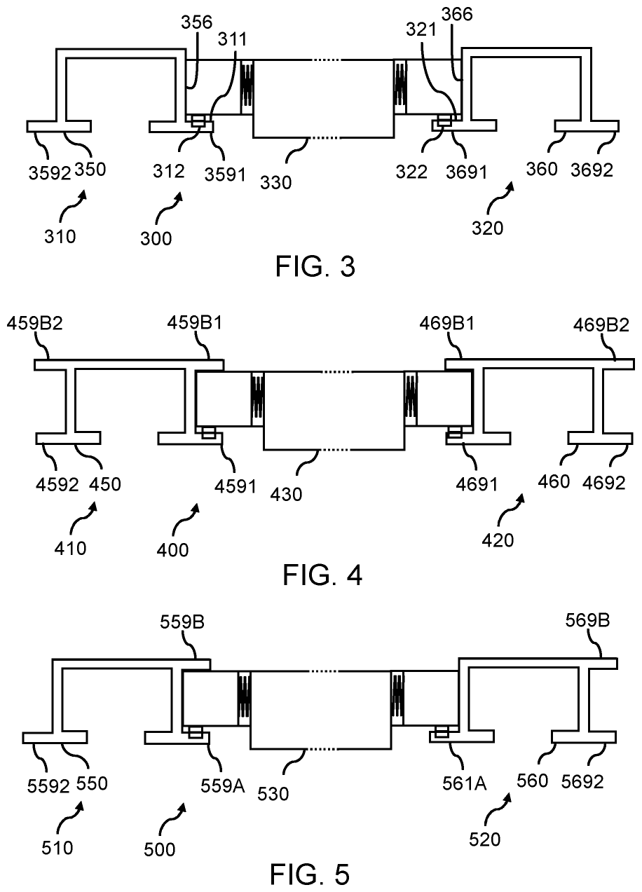

FIG. 3 provides a sectional view of another lighting system 300, which is a variation to the lighting system 200 previously described with reference to FIG. 2.

The lighting system again comprises a plurality of power tracks 310, 320 (of which two are illustrated) and one or more lighting panels 330 (one of which is illustrated).

The power tracks 310, 320 differ from the previous embodiment of a lighting system 200 in that the upper surface 311, 321 (on which a lighting panel rests) is to a side of the housing 350 of each power track, rather than on top of said housing. To accommodate such an upper surface, the housing 350, 360 of each power track comprises one or more sidewards projection 3591, 3592, 3691, 3692.

The electrical contacts 312, 322 are positioned on the sidewards projection(s) of the housing 350, 360 of the corresponding power track 310, 320.

Although present, the power/return line(s), as well as the electrical interconnect between the electrical contact(s) and the power line or return line, carried by each power track is not illustrated for the sake of illustrative clarity.

The other elements of the lighting system 300 are functionally similar/identical to the elements of the previously described embodiment of the lighting system 200, and are not repeated for the sake of conciseness.

Of course, the projection(s) can be omitted, as their function is effectively replaced by a side wall 356, 366 of the housing. Thus, the biasing element(s) may be configured to push the support against a sidewall 356, 366 of the housing.

FIG. 4 illustrates a sectional view of another lighting system 400, which is a variation to the lighting system 300 previously described with reference to FIG. 3.

The lighting system 400 again comprises a plurality of power tracks 410, 420 (of which two are illustrated) and one or more lighting panels 430 (one of which is illustrated).

The power tracks 410, 420 differ from the previously described lighting system 300 in that (as well as the sidewards projections 4591, 4592, 4691, 4692) the housing 450, 460 of each power track 410, 420 further comprises one or more additional sidewards projections 459B1, 459B2, 469B1, 469B2. The additional sidewards projections provide additional support to the lighting panel 430. In particular, the lighting panel 430 is configured to be positioned between a sidewards projection 459A and an additional sidewards projection 459B of each power track in the set of power tracks.

The other elements of the lighting system 400 are functionally similar/identical to the elements of the previously described embodiment of the lighting system 300, and are not repeated for the sake of conciseness.

FIG. 5 illustrates a sectional view of another lighting system 500, which is a variation to the lighting system 400 previously described with reference to FIG. 5.

The lighting system 500 again comprises a plurality of power tracks 510, 520 (of which two are illustrated) and one or more lighting panels 530 (one of which is illustrated).

The power tracks 510, 520 differ from the previously described lighting system 400 in that one of the additional sidewards projections of each power track is omitted. Thus, only a single additional sideward projection 459B, 459B is provided. Thus, an asymmetric power track is provided.

This embodiment still provides good structural support for the lighting panel 530, whilst making it easier to install the lighting panel 530 between the power tracks 510, 520. The other elements of the lighting system 500 are functionally similar/identical to the elements of the previously described embodiment of the lighting system 300, and are not repeated for the sake of conciseness.

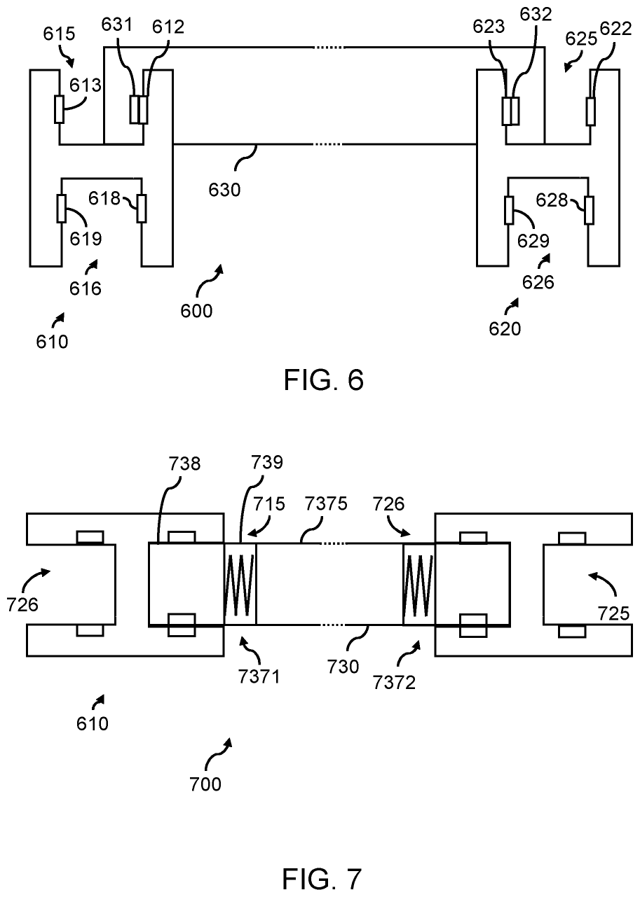

FIG. 6 provides a sectional view of a portion of another lighting system 600. The lighting system 600 again comprises a plurality of power tracks 610, 620 (of which two are illustrated) and one or more lighting panels 630 (one of which is illustrated).

Each power track 610, 620 comprises a first cavity 615, 625 configured to face a first direction (e.g., towards a ceiling) and a second cavity 616, 626 configured to face away a second opposite direction (e.g., away from the ceiling). In this way, an opening to the first cavity 615, 625 and an opening to the second cavity 616, 626 are configured to face opposite directions (e.g., up and down).

The cross-section of each power track 610, 620 is effectively H-shaped.

The lighting panel 630 is configured to mechanically couple to the first cavity 615, 625 of each power track. In particular, the lighting panel is configured to mechanically couple to the bounds of the first cavity, e.g., using a hook or other geometrically matching structure.

Electrical contact(s) 612, 613, 622, 623 for the power line and the return line are present in the first cavity of each power line. The lighting panel comprises connectors 631, 632 for connecting to an electrical contact 612 for a power line and an electrical contact 623 for a return line, to thereby power the lighting panel.

The second cavity 616, 626 may also comprise or carry electrical contacts 618, 619, 628, 629 for the power line and the return line.

In this way, each power track is effectively embodied as a pair of (conventional) power tracks that are positioned back-to-back. In particular, the electrical contacts in the first cavity act as a power line and return line for a first conceptual power track and the electrical contacts in the second cavity as a power line and return line for a second conceptual power track.

In particular, the proposed approach can effectively provide an upwardly facing and downwardly facing power track. This provides additional advantages. The upwardly facing power track can enable ease of connecting the power track to a power supply (e.g., positioned in a ceiling), as well as mechanically and electrically coupling to the lighting panel. The downwardly facing power track can be used, in a conventional manner, for the placement and powering of lights, spotlights or sensors.

FIG. 7 is a sectional view illustrating another embodiment of a lighting system 700, which is a variation of the previously described lighting system 600. The lighting system 700 again comprises a plurality of power tracks 710, 720 (of which two are illustrated) and one or more lighting panels 730 (one of which is illustrated).

In this variation, the first and second cavity are configured to face away from another in directions parallel to a ceiling (i.e., horizontally). In this way, an opening to the first cavity 715, 725 and an opening to the second cavity 716, 726 are configured to face opposite directions (e.g., left and right).

The cross-section of each power track 710, 720 remains effectively H-shaped.

In this approach, there is effectively provided a left facing and right facing power track. This appearance is similar to the embodiment 400 described with reference to FIG. 4, excepting that there is no downwards facing cavity carrying power/return lines. Rather, there are two sideways facing cavities, each carrying power/return lines.

The lighting panel 730 rests within a respective cavity 715, 726 of two power tracks 710, 720, where the cavities face one another, and electrically connects to at least one power line and at least one return line carried in each cavity. In the illustrated example, the lighting panel connects to a power line carried by one power line 710 and a return line carried by another power line 720.

The use of one or more biasing elements 739 to bias a respective one or more movable supports 738 (which carry the electrical connector(s) of the lighting panel) is particularly useful in this embodiment, to enable insertion of the lighting panel between the power tracks.

In particular, the lighting panel 730 can be formed of a main body 7375 and two or more coupling elements 7371, 7372. One or more of the coupling elements 7371, 7372 may comprise a moveable support 738 and a biasing element 739.

In the previously described embodiments, the lighting panel couples to a power line on one power track and a return line on another power track. However, this is not essential. Rather, the light panel and power track(s) may be configured so that the lighting panel is able to connect to the power line and return line on a single power track.

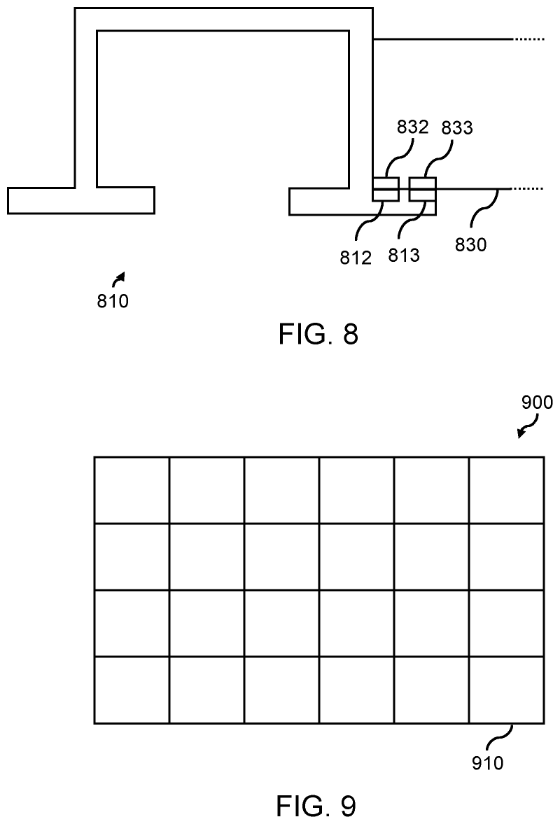

FIG. 8 illustrates an example configuration in which a single power track 810 provides an electrical contact 812 for the power line and an electrical contact 813 for the return line that electrically connect to respective connectors 832, 833 of the lighting panel 830. Thus, a single connection arrangement is able to provide both a power and return line via a same, single power track.

It will be appreciated that the other side of the lighting panel (not shown) does not need to electrically connect to any power/return lines, even if available, on another power track.

The remaining structure of the power track 810 is similar to the embodiment described with reference to FIG. 3. However, the skilled person will appreciate that the connection arrangement illustrated in FIG. 8 can be used in any other embodiment.

FIG. 9 illustrates one arrangement 900 for the plurality of power tracks 910.

In this arrangement 900, the power tracks are arranged in a rectilinear grid or grid-like format. The power tracks thereby define a plurality of enclosed or bounded segments. Each segment may be filled or occupied by a lighting panel. In other words, one or more lighting panels can be positioned within each enclosed/bounded segment defined by the plurality of power tracks 910.

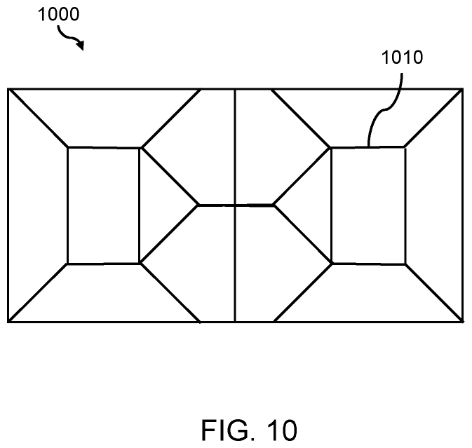

FIG. 10 illustrates another arrangement 1000 for the plurality of power tracks 1010. In this arrangement, the power tracks are arranged in a predetermined non-rectilinear pattern. The example pattern is merely an example to demonstrate how the power tracks need not be arranged to be only parallel and/or perpendicular to one another (i.e., rectilinearly).

Thus, the power tracks do not necessarily need to be arranged in a rectilinear grid, but may also support other angles (e.g. 300 or 60°). By doing so, the power tracks can themselves form a decorative pattern.

By offering a (limited) number of different lighting panel shapes, a large variety of decorative luminous ceiling patterns can be enabled while still maintaining large parts of the ceiling to remain open, while the power tracks further enable flexible placement of pendant lights, spotlights, sensor devices etc.

It will be appreciated that the lighting panel(s) may be appropriately shaped or configured to fit within the spaces between power tracks formed in a non-grid arrangement.

It is not essential that the light outputting surface of the lighting panel completely fills an enclosed segment of the plurality of power tracks. Rather, the light outputting surface could only partially fill this cell, whilst the overall lighting panel continues to receive power and continues to be mechanically supported by at least two of the tracks surrounding the cell.

As previously explained, one or more of the power tracks may be replaced by a lighting track, particularly a linear lighting track. A lighting track is formed of a rigid material and carries one or more elongate light emitting elements.

Thus, the example arrangements 900, 1000 illustrated in FIG. 9 or 10 could equally represent example arrangements of one or more power tracks and one or more lighting tracks.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A lighting system comprising:
a plurality of power tracks lying in a first plane, each power track being formed from a rigid material and carrying one or more power lines for carrying power and comprising an upper surface configured for suspension of the power track from a ceiling; and
one or more lighting panels for emitting light, each lighting panel being:
mechanically coupled to a respective set of power tracks, comprising at least two of the plurality of power tracks, to thereby be structurally supported by the respective set of power tracks; and
configured to draw power from the one or more of the power lines,
wherein each power track comprises a housing defining a cavity having an interior surface of a wall facing the cavity and having an opening facing in a direction away from the upper surface of the power track,
wherein the one or more power lines are carried on the interior surface within the cavity of the housing, the cavity of the housing and one or more power lines being configured for the placement and powering of an electrical device,
each power track comprises electrical contacts on the upper surface, the upper surface being configured for facing the ceiling and mechanically coupling to the lighting panel, and the electrical contacts being configured, for electrically coupling to the lighting panel; and
each lighting panel is configured to rest upon the upper surface of each power track of the respective set of power tracks to thereby mechanically couple the lighting panel to the respective set of power tracks.

2. The lighting system of claim 1, comprising a first set of one/two or more coupling elements configured for providing mechanical coupling to a first power track, and a second set of one/two or more coupling elements configured for providing mechanical coupling to a second power track.

3. The lighting system of claim 1, wherein:
each power track further comprises one or more return lines providing a return path for power; and
each lighting panel is configured to electrically connect to one or more of the return lines carried by the respective set of power tracks.

4. The lighting system of claim 3, wherein each lighting panel is configured to electrically connect to at least one power line and at least one return line carried by a single one of the power tracks in the respective set of power tracks.

5. The lighting system of claim 3, wherein each lighting panel is configured to:
electrically connect to a power line carried by one of the power tracks in the respective set of power tracks; and
electrically connect to a return line carried by another one of the power tracks in the respective set of power tracks.

6. The lighting system of claim 1, wherein each lighting panel comprises one or more coupling elements configured to mechanically couple the lighting panel to the respective set of tracks and/or electrically couple the lighting panel to one or more power lines carried by the respective set of power tracks.

7. The lighting system of claim 6, wherein, for each lighting panel, at least one coupling element is detachably connected to the remainder of the lighting panel.

8. The lighting system of claim 1, wherein:
each power track carries at least one electrical contact positioned on the upper surface of the power track, each electrical contact being electrically connected to one of the one or more power lines carried by the power track; and
each lighting panel is configured to electrically connect to one or more of the electrical contacts carried by the respective set of power tracks.

9. The lighting system of claim 8, wherein:
each power track comprises a projection that extends upwardly from the upper surface; and
each lighting panel comprises:
at least one electrical connector, each configured to electrically connect to at least one electrical contact carried by a single one of the respective set of power tracks; and
for each electrical connector: a moveable support configured to structurally support the electrical connector; and a biasing element configured to push the moveable support against the projection of the single one of the respective set of power tracks.

10. The lighting system of claim 1, wherein each power track comprises:
a first cavity, carrying a first power line, and having an opening that faces a first direction; and
a second cavity, carrying a second power line, having an opening that faces a second, opposite direction,
wherein each lighting panel is configured to electrically connect to the first power line carried by one of the power tracks in the respective set of power tracks.

11. The lighting system of claim 1, wherein the plurality of power tracks comprises at least 10 power tracks.

12. The lighting system of claim 1, wherein the one or more power tracks are arranged in a first grid pattern or geometric pattern.

13. The lighting system of claim 1, further comprising one or more lighting tracks, each lighting track being formed of a rigid material and carrying one or more elongate light emitting elements.

14. The lighting system of claim 13, wherein the one or more power tracks and the one or more lighting tracks are arranged in a second grid or geometric pattern.
